(19) United States
(12) Patent Application Publication
(10) Pub. No.: US 2010/0237870 A1
(43) Pub. Date: Sep. 23, 2010

(54) Geophysical Prospecting Using Electric And Magnetic Components Of Natural Electromagnetic Fields

(75) Inventor: Jack Dodds, Aurora (CA)

Correspondence Address: NOVAK DRUCE + QUIGG LLP, 300 NEW JERSEY AVENUE, NW, FIFTH FLOOR, WASHINGTON, DC, 20001, US

(73) Assignee: Geo Equipment Manufacturing Limited, Aurora (CA)

(21) Appl. No.: 12/725,727

(22) Filed: Mar. 17, 2010

Related U.S. Application Data
(60) Provisional application No. 61/160,722, filed on Mar. 17, 2009.

(51) Int. Cl. G01V 3/16

(52) U.S. Cl. 324/331

(57) ABSTRACT

A geophysical survey system comprising: a first sensor system towed by an aircraft, having at least one airborne sensor for measuring electric components of a low frequency natural electromagnetic field in a survey area; a second sensor system for positioning at a fixed position on the ground during a survey, having at least two ground based induction coil sensors for measuring magnetic components of a low frequency natural electromagnetic field in or near the survey area, the ground based sensors each being oriented to sense the magnetic components in different directions; and a processing system for calculating a set of first vector values over time in dependence on the electric components measured through the first sensor system and calculating a set of second vector values over time in dependence on the magnetic components measured through the second sensor system and comparing one or more characteristics of the first vector values and the second vector values to identify geophysical information about the survey area.

This application claims the benefit of and priority to U.S. Patent Application No. 61/160,722 filed Mar. 17, 2009, the content of which is incorporated herein by reference.

### FIELD

This description relates to a multiple electric and magnetic field receiver system and apparatus for airborne geophysical surveying.

### BACKGROUND OF THE INVENTION

Geophysical electromagnetic (“EM”) prospecting techniques can be effective in determining the electrical conductivity of soils, rocks, and other bodies at and under the earth's surface.

Geophysical EM prospecting can be carried out using surface based equipment and airborne equipment. Airborne methods in which equipment is transported by aircraft such as helicopter, airplane or airship may be useful for large area surveys. For airborne electromagnetic (“AEM”) systems, survey data may be acquired while an aircraft such as an airplane or helicopter flies at a nearly constant speed along nearly-parallel and close to equally-spaced lines at an approximately constant height above ground. In some applications, geophysical EM prospecting of a seabed may be carried out using equipment located under the surface of a body of water.

Some geophysical surveying methods are active in that the equipment is used to transmit a signal to a targeted area, and then measure a response to the transmitted signal. Other geophysical surveying methods are passive in that signals produced from a target area are measured without first transmitting a signal to the target area.

An example of a passive geophysical EM prospecting method is Audio Frequency Magnetic (“AFMAG”) surveying in which the EM fields resulting from naturally occurring primary signal sources such as lightning discharges are measured. These EM fields propagate around the earth as plane waves guided by the ionosphere and earth's surface. Lightning activity occurring remote from the measurement point can produce signals with an approximately flat spectral density at frequencies between, for example, 8 Hz and 500 Hz, varying with geographical location, time of the day, seasons and weather conditions. An example of a passive AFMAG geophysical EM prospecting method is shown in U.S. Pat. No. 6,876,202.

### SUMMARY

A geophysical survey system comprising: a first sensor system towed by an aircraft, having at least one airborne sensor for measuring electric components of a low frequency natural electromagnetic field in a survey area; a second sensor system for positioning at a fixed position on the ground during a survey, having at least two ground based induction coil sensors for measuring magnetic components of a low frequency natural electromagnetic field in or near the survey area, the ground based sensors each being oriented to sense the magnetic components in different directions; and a processing system for calculating a set of first vector values over time in dependence on the electric components measured through the first sensor system and calculating a set of second vector values over time in dependence on the magnetic components measured through the second sensor system and comparing one or more characteristics of the first vector values and the second vector values to identify geophysical information about the survey area.

According to another example embodiments is a method of conducting a geophysical survey of a survey region, comprising: measuring, using a towed airborne sensor system an electric component of a low frequency natural electromagnetic field in a survey area; measuring, at a ground based sensor system during a survey, magnetic field components of the low frequency natural electromagnetic field in or near the survey area using at least two stationary induction coil sensors each being oriented to sense the magnetic field in different directions; and calculating a set of first vector values over time in dependence on electromagnetic field data measured through the airborne sensor system and calculating a set of second vector values over time in dependence on electromagnetic field data measured through the ground based sensor system and comparing one or more characteristics of the first vector values and the second vector values to identify geophysical information about the survey area.

According to another example embodiment is an airborne sensor system for geophysical surveying, the airborne sensor system being towable by an aircraft and comprising: a continuous tubular support frame defining at least one internal tubular passage; and a plurality of conductive antenna elements supported at spaced apart locations within the internal tubular passage for measuring electric components of low frequency natural electromagnetic field in a survey area, the antenna elements each having a different relative orientation and measuring the electric components in at least two different relative directions.

### BRIEF DESCRIPTION OF THE DRAWINGS

Example embodiments of the invention are provided in the following description. Such description makes reference to the annexed drawings wherein:

FIG. 1 is a perspective view of a geophysical surveying system according to an example embodiment, the system including an airborne multiple electric field sensor assembly, being towed by a helicopter, an associated ground-based multiple magnetic field sensor assembly, and related processing equipment.

FIG. 2A is a sectional plan view of the electric sensor assembly of FIG. 1, showing a cutaway outer shell and the structure inside the shell.

FIG. 2B is a vertical cross section through the electric sensor assembly of FIG. 1, taken along the lines 2B-2B of FIG. 2A.

FIG. 3 is a vertical cross section through the electric sensor assembly of FIG. 1, taken along the lines 2B-2B of FIG. 2A, illustrating an elastic suspension system that isolates the inner part of the electric sensor assembly from vibration according to an example embodiment.

FIG. 4 is a sectional view taken along lines IV-IV of FIG. 3.

FIG. 5 is a vertical cross section through the electric sensor assembly of FIG. 1, taken along the lines 2B-2B of FIG. 2A, illustrating an alternative two stage elastic suspension system according to an alternative embodiment.

FIG. 6 is a sectional view taken along lines VI-VI of FIG. 5.

FIG. 7 shows a simplified schematic diagram of a high input impedance amplifier which is included in amplifier packages of the airborne multiple electric field sensor assembly of the system of FIG. 1.

FIG. 8 shows a block diagram of an electronics package of the airborne multiple electric field sensor assembly of the system of FIG. 1.

FIG. 9 shows an alternative electric field sensor assembly.

FIG. 10 is a vertical cross section through the electric sensor assembly of FIG. 1, taken along the lines 2B-2B of FIG. 2A, illustrating a further alternative two stage elastic suspension system according to an alternative embodiment.

FIG. 11 is a sectional view taken along lines XI-XI of FIG. 10.

### DESCRIPTION OF EXAMPLE EMBODIMENTS

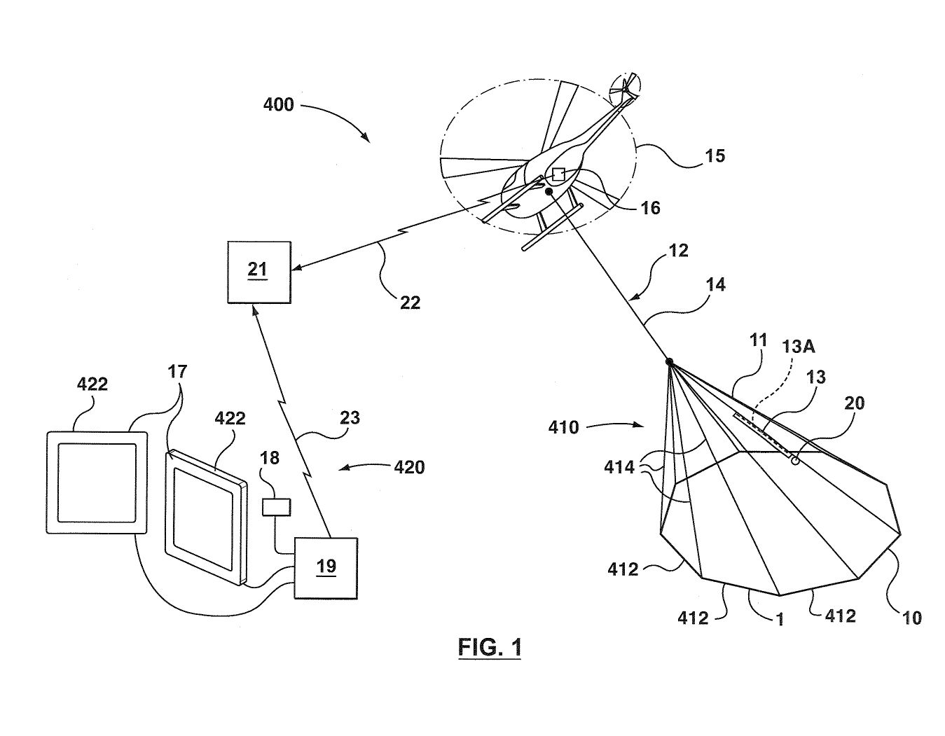

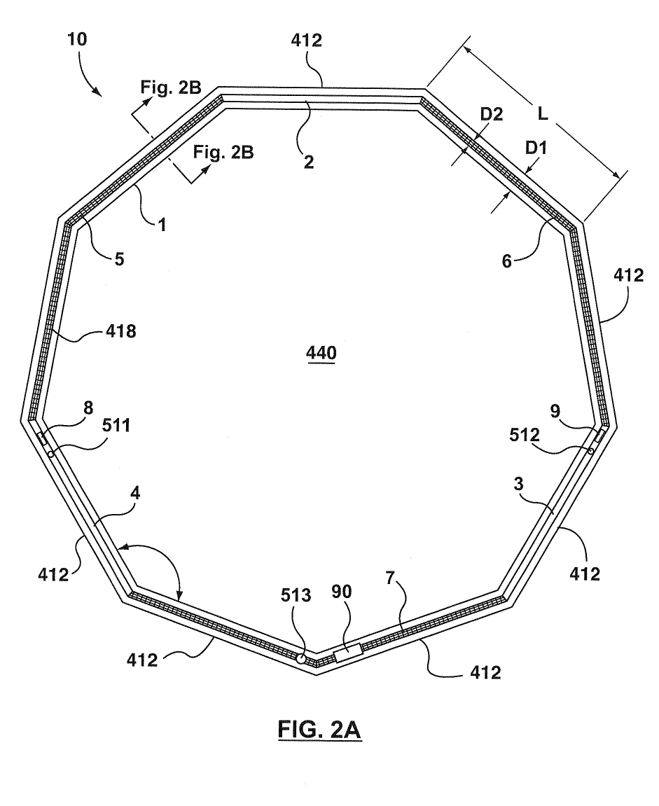

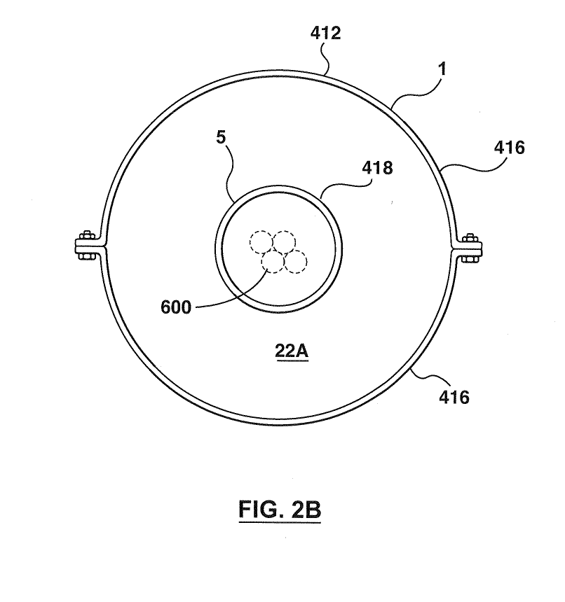

FIG. 1 illustrates a geophysical surveying system 400 according to an example embodiment. The surveying system 400 includes an airborne tow assembly sensor system 410, a ground assembly sensor system 420 and processing system 21. The tow assembly 410 includes a multiple electric field sensor assembly 10 for geophysical surveying, with a suspension system 11 and non-conductive mechanical tow cable 14 for towing by a helicopter 15. The sensor assembly 10 includes a support frame or shell 1 that is formed from a plurality of elongate tubular members 412 that are serially connected together end to end to form a shape that is circular or approximates a circle. In the illustrated embodiment, adjacent tubular members 412 are each connected together at an obtuse angle α (FIG. 2A) to from a nine-sided polygonal shape, although many other frame shapes and configurations are possible During use, the sensor assembly 10 is towed in a substantially horizontal orientation. The suspension system 11 can be formed from a plurality of ropes 414 as shown in FIG. 1, each of which has a lower end connected to a respective corner of the support frame of shell 1 and an upper end connected to a lower end of tow cable 14. Examples of appropriate suspension and tow systems are the multiple rope system described for example in U.S. Pat. No. 7,157,914 or the suspension net structure as described in International Application publication No. WO2008/071006, both of which are incorporated herein by reference. In some embodiments, the tow assembly sensor system 410 includes an auxiliary vertical field electric sensor assembly 13 and amplifier assembly 20 which are attached to one or more of the of the ropes 414 of the suspension system 11 at, for example, a position which is directly above the center of the sensor assembly 10. In at least some example embodiments the vertical field electric sensor assembly 13 includes an antenna element in the form of an elongate conductive tubular section 13A.

The tow assembly sensor system 410 includes a communications link such as a non-conductive cable 12 containing optical fibers to allow bidirectional data transmission between the electric field sensor assembly 10 and airborne data processing equipment 16 located in the helicopter. In some example embodiments, the suspension system 11 reduces the vibration of the conductive elements of the electric field sensor assemblies 10 and 13, so as to reduce the noise generated by motion in the geomagnetic and static electric field of the earth. The use of the non-conductive fiber cable 12 and non-conductive tow cable 14 mitigates against distortions and fluctuations of the electric field that could otherwise be caused by a vertical conductor between the helicopter and the electric field sensor assemblies. In at least some example embodiments, the use of an electric field sensor assembly which is physically large, instead of a smaller, enclosed, streamlined “bird”, enhances the data quality while keeping the weight of the system within the range that can be towed by a small helicopter.

As shown in FIG. 1, the ground assembly sensor system 420 includes a two component horizontal magnetic field sensor assembly 17 consisting of two induction coils 422 with horizontal axes, substantially perpendicular to each other, which is located on the ground. Ground assembly 420 also includes a GPS receiver 18 and ground based data collection computer 19. Signals from the magnetic sensor assembly 17 and from the GPS receiver 18 are connected to ground based data collection computer 19. Although FIG. 1 shows large air core coils 422, these sensors can also be constructed using windings on a ferromagnetic cores, and in that case the sensors would be long and cylindrical in shape. Other alternative example embodiments could include three ground based sensor coils, each with its axis at an angle to the others, so that the horizontal magnetic field components can be calculated by combining the outputs of the three sensors with appropriate coefficients.

The ground-based magnetic sensor assembly 17 and data collection computer 19 of ground assembly sensor system 420 are designed using known techniques so that their combined noise floor is substantially less than the magnetic component of electromagnetic fields usually caused by distant natural sources at intervals of 1-10 s in the 10 Hz-1,000 Hz frequency range. For example, in some implementations the noise floor spectral density may be on the order of 3 fT/√Hz at 30 Hz, decreasing to the order of 0.2 fT/√Hz at 1,000 Hz. By way of further example, in some implementations the noise floor spectral density may be on the order of 10 fT/√Hz at 30 Hz, decreasing to the order of 1 fT/√Hz at 1,000 Hz. It is well known that this performance can be achieved by making the sensor coils sufficiently large. With this configuration and performance, the magnetic sensor assembly 17 provides vector measurements of the horizontal magnetic component of the naturally occurring electromagnetic field. In at least some example embodiments, such a ground assembly configuration provides substantially more useful information in the 10 Hz-1 kHz range than is provided by a commercially available total field magnetometer such as a cesium magnetometer.

FIG. 2A is a sectional plan view of the electric field sensor assembly 10 with the external shell 1 cut away to show the inner structure, according to an example embodiment. The external shell 1 is non-conductive. In some embodiments it is constructed of lengths of non-conductive tubing (e.g. tubular members 412). In some embodiments, tubular members 412 are constructed of half-cylinder components 416 (FIG. 2B) which are attached together in pairs. Within the external shell 5 is suspended an inner assembly 418 consisting of conductive sections 5, 6, 7 (also referred to herein as antenna elements), and non-conductive sections 2, 3, 4. FIG. 2B shows the location of the inner assembly 418 centrally suspended within the external shell 1. Each conductive section 5, 6, 7 is separated and electrically isolated from the other conductive sections 5, 6, 7 by a non-conductive section 2, 3, 4, such that the inner assembly 418 is made up of alternating conductive and non-conductive sections that are joined at elbow sections of the inner assembly 418 to collectively form a structure that is suspended within the continuous internal passage defined within the tubular members 412 of the shell 1. In the illustrated embodiment, the inner assembly 418 has a shape that matches that of the shell 412—i.e. it is a polygonal loop-like structure that approximates a circle. In an example embodiment, each of the conductive sections 5, 6 and 7 are substantially identical tubular conductive sections that include a central bend and extend the length of two outer tubular members 412. The non-conductive intermediate sections 2, 3, 4 are each tubular members that extend the length of one tubular outer member 412. By way of non-limiting illustrative example, in one implementation the polygonal fame or shell 1 could have an overall diameter of approximately 8.5 meters, and each side of the polygonal frame or shell 1 may have a length “L” of approximately 3 meters, and an inside diameter “D1” of 30 cm, with each tubular conductive section 5, 6, 7 having a length of approximately 6 meters and a diameter “D2” of 10 cm and each tubular non-conductive section 2, 3, 4 having a length of approximately 3 meters and a diameter of 10 cm. However, such dimensions are merely illustrative and many other dimensions are possible.

The inner assembly 418 supports amplifier packages 8 and 9 and data acquisition package 90. As will be explained in greater detail below, amplifier package 8 receives input signals from conductive section 5 and amplifier package 9 receives input signals from conductive section 6. The previously mentioned amplifier package 20 associated with vertical electric field sensor assembly 13 receives input signals from conductive section 13A. The local commons or grounds of amplifier packages 8, 9 and 20 are electrically connected to conductive element 7, which is therefore the common element and the reference for all electrical field measurements such that conductive section 5 in combination with conductive section 7 and amplifier package 8 provides a first electric field sensor for measuring electric components of a naturally occurring magnetic field in a first direction; conductive section 6 in combination with conductive section 7 and amplifier package 9 provides a second electric field sensor for measuring electric components of the magnetic field in a second direction; and conductive section 13A (of vertical sensor assembly 13) in combination with conductive section 7 and amplifier package 20 provides a third electric field sensor for measuring electric components of the magnetic field in a third direction. In the illustrated embodiment, a data acquisition package 90 for receiving the outputs of amplifier packages 8, 9 and 20 is located in one of the outer tubular members 412 that houses reference conductive section 7. The amplifier packages 8, 9 are respectively located in tubular members 412 that house the non-conductive sections 3 and 4 between section 7 and each of the other conductive sections 5 and 6, and are positioned distant from conductive section 7 and close to the each of the other conductive sections 5 and 6. In some example embodiments, three GPS antennas 511, 512 and 513 are provided at spatially separated locations within or on the shell 1 to allow the orientation of the airborne electric sensor assembly to be determined. The conductive sections 5, 6, 7 and conductive section 13A of vertical field electric sensor assembly 13 are each electric field antenna elements that are supported in constant positions relative to each other during flight.

In at least some example implementations, the above described arrangement of the electric field sensor assembly 10 maximizes or allows for increased electrical signal strength by providing three conductive antenna elements 5, 6 and 7 of large self capacitance, separated from each other by a large distance, and isolated from airflow induced vibration, within an assembly 10 which is large, and yet light and with sufficiently low drag to be towed by a helicopter. The three conductive antenna elements 5, 6 and 7 are arranged in a non-colinear array enabling the airborne sensor system to independently measure at least two perpendicular electric components of the low frequency natural electromagnetic field. In example embodiments the support frame or shell 1 is a loop-like continuous tubular skeletal frame that can support spatially separated antenna elements in substantially constant relative positions in an internal continuous tubular passage while having a relatively light weight by defining a large central area or opening 440 through which air can pass. In example embodiments, the surface area, volume, and weight of the physical components of the shell 1 is small, considering the total spatial volume occupied by shell 1 (including opening 440,) is so that the conductive sections 5, 6, 7 have a large spatial separation from each other relative to the weight of the sensor assembly 10. Similarly, the suspension system 11 allows vertical e-field sensor assembly 13 (including its antenna element 13A) to be supported in a relatively constant position to the shell 1 with the sensor assembly 13 spatially separated from the horizontally oriented conductive elements that are located in shell 1.

Other example embodiments could contain two, four, or more conductive sections, with corresponding limitation or enhancement of the number of electric field directions that could be independently measured. Instead of sharing a common conductive element 7 among a plurality of electric field sensors, each sensor could be provided with its own reference conductive element. The vertical electric field sensor 13 could be omitted. The shell 1 could have a different number of straight or curved sections. Also, a more complex structure could be used, such as an octahedron structure. By way of example, a suitable octahedron structure for a tow assembly is described in U.S. patent application Ser. No. 12/645,915 filed Dec. 23, 2009 and International Patent Application No. PCT/CA2009/001865 claiming priority to U.S. Patent application No. 61/140,337, the contents of which are all incorporated herein by reference.

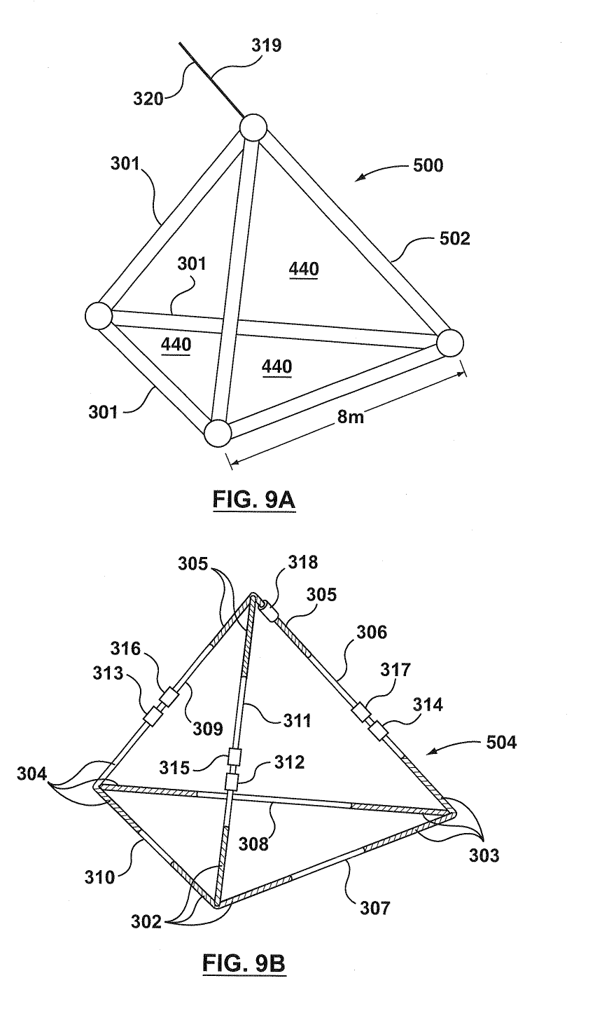

By way of further example, FIGS. 9A and 9B show another possible embodiment of an airborne electric sensor assembly 500. FIG. 9A shows the non-conductive external frame or shell 502 of the assembly 500, which in this example embodiment is a structure in the form of a regular tetrahedron. The edges of the tetrahedron assembly 500 are tubes 301 forming an internal passage or space within which an inner assembly 504 is supported by an elastic suspension system. The inner assembly 504 is shown in FIG. 9B. It consists of four conductive sections 302, 303, 304, 305 (each consisting of three conductive tubes joined at a common apex, and shown cross-hatched), and non-conductive sections 306, 307, 308, 309, 310, 311. Each conductive section is separated and electrically isolated from the other conductive sections by a non-conductive section. The inner assembly supports amplifier packages 312, 313, 314 and data acquisition package 318. The data acquisition package 318 is located in an area of one of the tubes 301 that supports conductive section 305. The amplifier packages 312, 313, 314 are located in the non-conductive sections between section 305 and each of the other conductive sections, and are positioned distant from conductive section 305 and close to the each of the other conductive sections. Three GPS antennas 315, 316, 317 allow the orientation of the airborne electric sensor assembly to be determined. The assembly is towed by a non-conductive cable 319 and the data acquisition package is linked to the helicopter by a fiber optic cable 320. In the complete system, as shown in FIG. 1, the example embodiment of the airborne assembly of FIG. 9 would take place of the airborne electric sensor assembly 10 and the additional components 13 and 20.

Although the example embodiment of the electric field sensor assembly in FIGS. 9A and 9B is different from that of FIG. 2A and 2B, in at least some example implementations it also maximizes or improves electrical signal strength by providing at least three conductive antenna elements of large self capacitance, separated from each other by a large distance, and isolated from airflow induced vibration, by a rigid, non-conductive external shell 502, within an assembly which is large and yet light and with sufficiently low drag to be towed by a helicopter. Shell 502 is skeletal in that the tubular shell members 301 define spaces or openings 440 through which air can pass so that the surface area, volume, and weight of the physical components of the shell 502 is small, considering the total spatial volume occupied by shell 502. Similar to shell 1, this configuration provides a structure that supports the airborne sensors in substantially constant locations relative to each other at relatively large spacing given the overall weight of the shell 502.

Other example embodiments could combine the electric field sensors with one or more coils that would sense magnetic fields. Specifically, in the example embodiment shown in FIGS. 2A and 2B, conductors could be routed through the non-conductive and conductive tubular sections 2, 3, 4, 5, 6, 7 and parallel to their axes, to form a multiple turn coil for sensing magnetic fields, so as to integrate the electric field sensor with a system like that described in U.S. Pat. No. 6,876,202 or U.S. patent application Ser. No. 12/645,915 filed Dec. 23, 2009 and International Patent Application No. PCT/CA2009/001865 claiming priority to U.S. patent application 61/140,337 (the contents of all of which are incorporated herein by reference) to provide additional types of electromagnetic signals for processing. In this regard, multiple turn receiver coil 600 is illustrated by dashed lines in FIG. 2B. The turns of the coil 600 would extend the entire circumference of the inner assembly 412, passing through each of the conductive antenna elements. In this case, the amplifiers connected to each of the antenna elements and the receiver coil 600 can be configured to maintain their inputs close to a common potential, minimizing the effect of the receiver coil 600 on the electric field signals received by the conductive antenna elements.

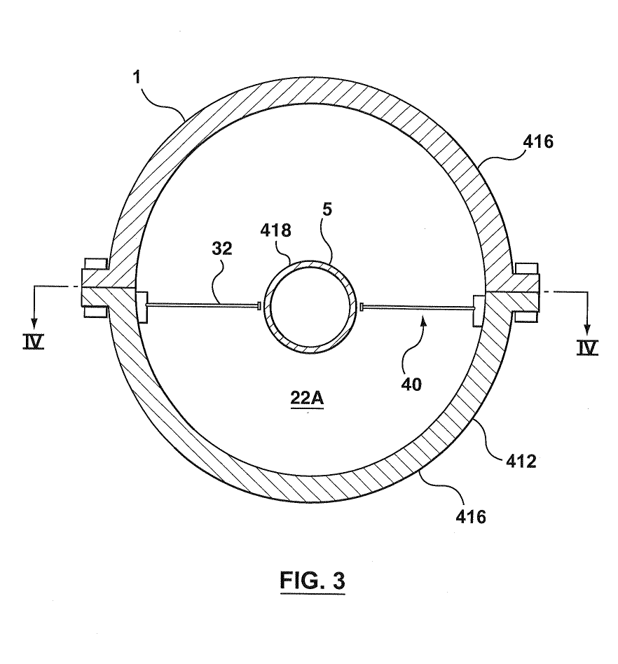

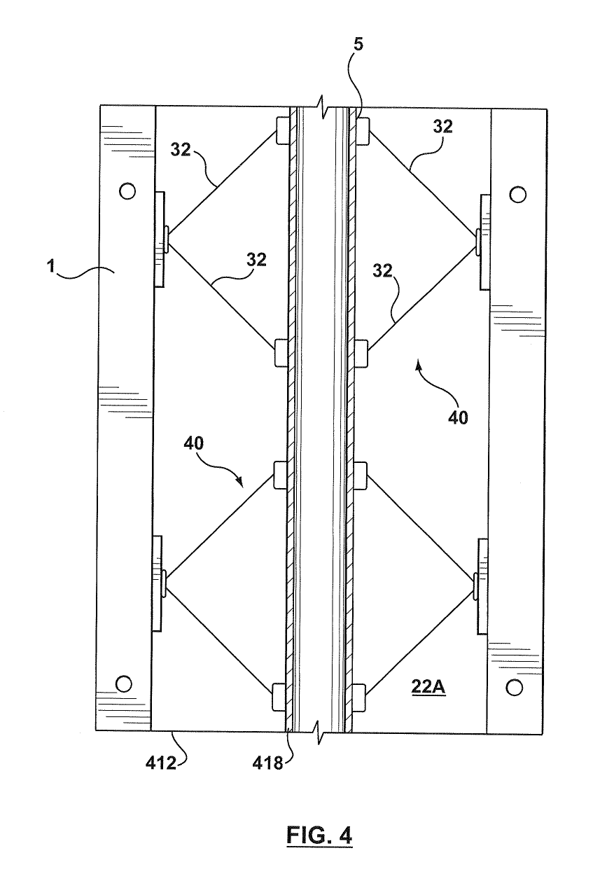

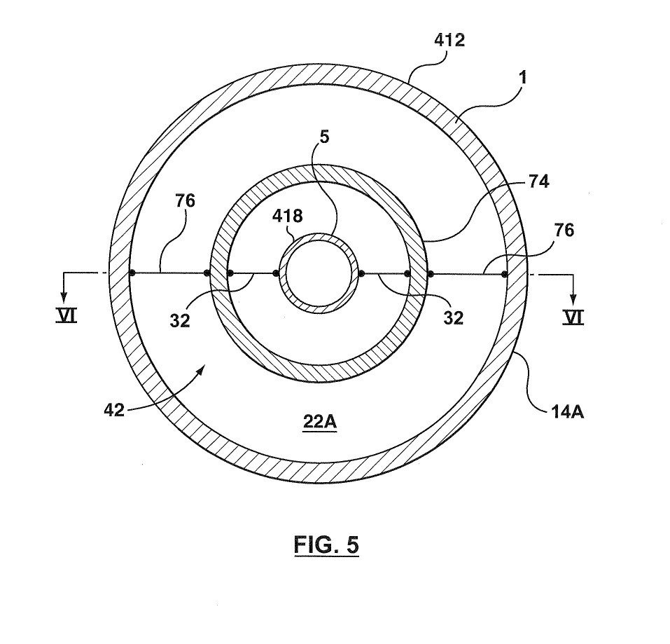

FIGS. 3 and 4 show details of an elastic suspension system 40 that could be used to suspend either the inner assembly 418 within the outer frame of shell 1 of the assembly 10 of FIG. 2A, or to suspend the inner assembly 504 within the outer frame or shell 502 of assembly 500 of FIGS. 9A and 9B. The elastic suspension system 40 will be described in the context of assembly 10 of FIG. 2A. The inner assembly 418 (in the cross-section views of FIGS. 3 and 5, the conductive section 5 is shown) is suspended by elastomeric cord 32 from the tubular members 412 of external shell 1 in a manner that provides support in all directions to centrally suspend the inner assembly 418 within the tubular passage way 22A defined within the shell 1. In this example embodiment, the elastomeric cord 32 is arranged in a zig-zag pattern to provide this support, but other configurations are possible. The elastomeric cord 32 may selected so that the mechanical resonant frequency of the suspension system and inner assembly 418 lies, for example, between 1 Hz and 10 Hz in all directions. The suspension system then reduces the mechanical coupling of vibration from the outer shell 1 to the inner assembly 418 at those frequencies that lie well above the resonant frequency, thereby reducing the noise generated by the motion of the conductive sections 5, 6, 7 and connecting wires in the geomagnetic and static electric field of the earth. In some example embodiments, the elastomeric cord 32 is prestressed, that is, it is installed under tension applying opposing forces on the inner assembly 418 so that the inner assembly 418 lies, or is biased to lie, in the center of the passage 22A within the outer shell 1 when the electric field sensor assembly 10 is stationary and in a horizontal orientation. To facilitate the prestressing method, in some example embodiments the suspension system 40 may be arranged so that the elastomeric cords 32 lie in a vertical plane, or in two or three planes that are inclined.

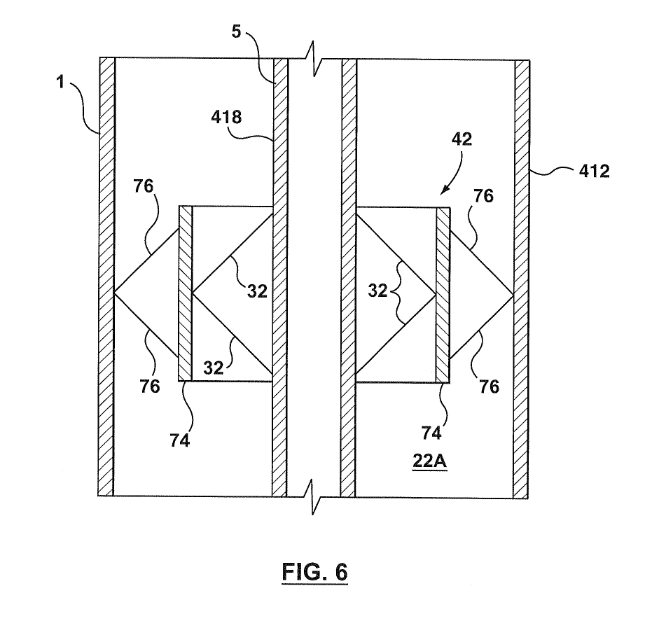

Other example embodiments of towed sensor assemblies 10, 500 uses a plurality of two stage elastic suspension systems 42 as shown in FIGS. 5 and 6 to provide enhanced vibration isolation. Here, the first stage of the suspension system 42 includes an intermediate non-conductive assembly 74 (which includes a rigid tubular section in the illustrated embodiment) that is centrally supported in passage 22A by elastomeric cords 76 that extend between the outer shell 1 and the intermediate non-conductive tubular assembly 74. In the illustrated embodiment, the elastomeric cords 76 are prestressed to apply opposing forces to centrally bias the intermediate assembly 76 within the center of the shell passage 22A. The intermediate assembly 74 supports the internal assembly 5 via a second stage of elastomeric cords 32 similar to the manner in which the internal assembly 5 is supported from shell 1 in the case of the single stage suspension described above. The elastomeric cords 32, 76, and the mass of the intermediate assembly 74, may be selected so that the mechanical resonant frequency of the combined intermediate assembly within the shell, and the mechanical resonant frequency of the inner assembly alone (measured by holding the intermediate assembly fixed) each lie, for example, between 1 Hz and 10 Hz. This provides two stages of vibration attenuation.

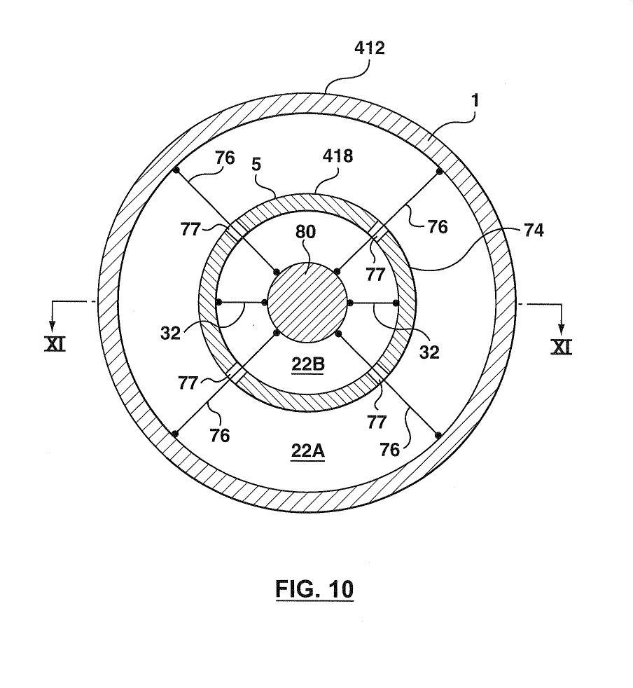

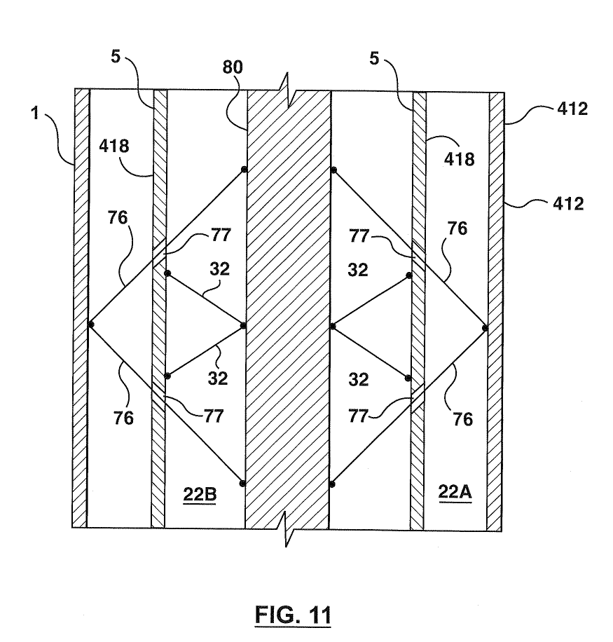

FIGS. 10 and 11 illustrate yet another two-stage suspension system that can be applied to towed sensor assemblies 10, 500. Considering sensor assembly 10, in this alternative double suspension system a rigid elongate intermediate member 80, which may for example be a metal rod or a non-conductive rod, is centrally suspended within the outer shell 1 by a first set of elastomeric cords 76 that extend between the tubular member 412 and the intermediate member 80 in such a manner to bias the intermediate member 80 in the center of passage 22A. The intermediate member 80 is centrally supported by elastomeric cords 76 within tubular inner assembly 418—in the portion shown in FIGS. 10 and 11, the intermediate member 80 is located within a passage 22B defined by the tubular conductive section 5, and through-holes 77 are provided through the conductive section 5 to allow the first set of elastomeric cords 76 to pass through the conductive section 5 to intermediate member 80. The conductive section 5 is in turn supported by a second set of elastomeric cords 32 that extend between the intermediate member 80 and the conductive section 5 such that the conductive section 5 is centrally biased in the passage 22A.

Although each of FIGS. 3 through 6 and 10 and 11 illustrate elastic suspension systems supporting conductive section 5, the remaining conductive and nonconductive sections of the inner assembly 418 can be supported in a similar manner.

The example tow assembly structures shown in FIG. 2, or alternatively that of FIG. 9, in at least some implementations provide large conductive elements, separated by a large distance, a compliant suspension (such as shown in the embodiments of FIGS. 3 through 6 and 10 and 11) that attenuates vibration, and a shell that provides protection from airflow and the vibration that it would cause. It provides a supporting structure to attenuate motion and vibration of the electrical cables that connect the conductive elements to the electronics. The structure is light enough to be towed by a helicopter and can be constructed of smaller components that can be easily disassembled for shipping. In at least some implementations, some of these characteristics may provide benefits over the use of an aerodynamic bird by providing increased signal amplitude, reduced source impedance, reduced noise, more convenient operation, and modular construction, although not all of these benefits may be present in all implementations. Some of these benefits may be realized in implementations which have a different number of straight sections, different cross sections for the outer shell or inner structure, or which are constructed of curved sections, without changing the principles of the design. In some implementations, the airborne tow assembly used in surveying system 400 may have a very different structure than the embodiments described above.

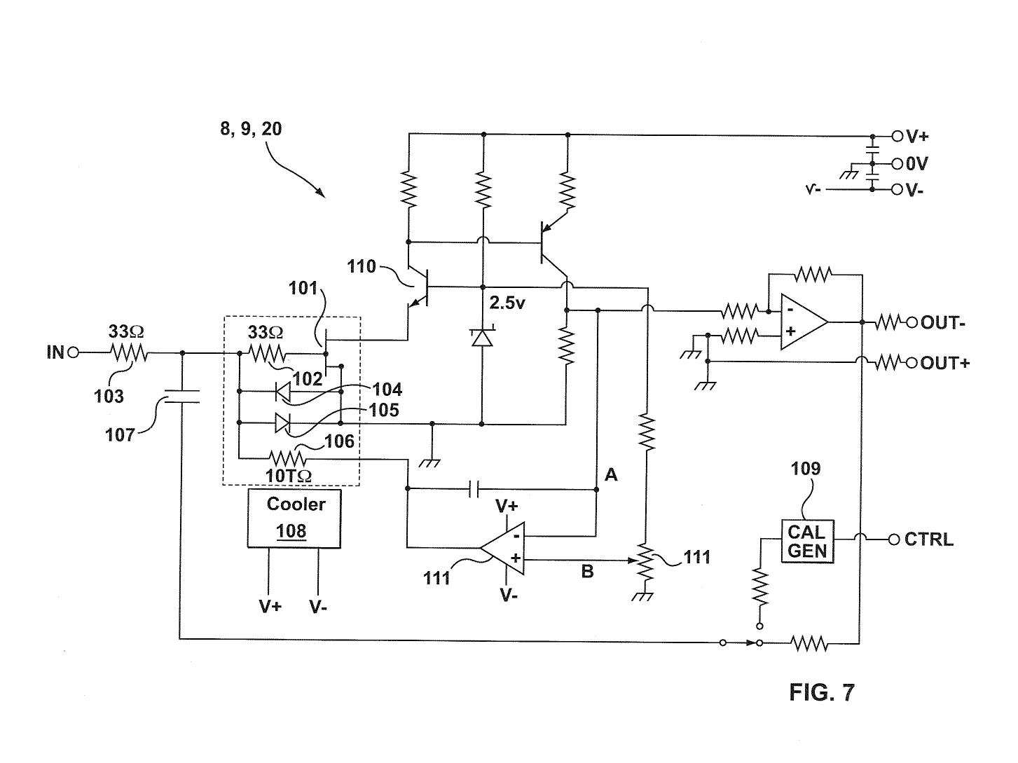

FIG. 7 shows a simplified schematic diagram of an amplifier circuit used in an example embodiment to implement each of the amplifier packages 8, 9, and 20 (or alternatively 313, 314, and 315). The amplifier circuit includes a low noise, JFET (or other suitable field effect transistor) input, cascode connected input stage. The JFET 101 and protective diodes 104 and 105 are biased at near zero input voltage to minimize leakage current and shot noise. The cascode circuit, including JFET 101 and low noise BJT 110, minimizes Miller effect capacitance. An offset cancellation circuit is implemented using op amp 111 connected as an integrator, with feedback through 10 Tohm resistor 106. As with any electronic circuit, many variations are possible.

The circuit of FIG. 7 includes a capacitor 107 which can be used in some implementations as a feedback capacitor. The value of the capacitor is selected so that it is precisely known and is much smaller than the self capacitance of an antenna element. In such an implementation, the conductive antenna elements 5, 6, 7 of the sensor assembly 10 and the conductive antenna element 13A in vertical sensor assembly 13 are maintained at the same electric potential and the output of each amplifier is a measure of the instantaneous charge that is required to maintain that potential on each element. A disadvantage of this implementation is that the elements will all interact, and if there is relative motion between them, it will be a source of noise.

In an alternative implementation, the capacitor 107 is used with calibration generator 109 to inject a small calibration signal into each antenna element. The frequency of the calibration signal is selected so that it is near the upper frequency limit of the entire system. A different calibration signal frequency is injected at each of the antenna elements. In the signals acquired from each antenna element, each calibration signal is separated from the others and from natural signals by known digital filtering techniques. When analyzed, the calibration signals provide a continuous measure of the sensitivity of each channel of the system and the coupling between channels.

In some implementations, the circuit of FIG. 7 includes a cooler 108 that is used to reduce the operating temperature of the JFET 101 and protective diodes 104 and 105 so as to reduce leakage current and thereby reduce amplifier input noise current. This cooler can be a commercially available Peltier effect device which provides a cooling effect of 40° C.-70° C., by way of non-limiting example.

In some implementations, an adjustment procedure is used with the circuit of FIG. 7 to minimize the bias on the JFET 101 and the protective diodes 104 and 105 so as to reduce leakage current and thereby reduce amplifier input noise current. The procedure is to ground the input terminal IN, then adjust trimpot 111 until the voltage difference between point A and point B is less than 10 mV, then to unground terminal IN. In some implementations, the cooler 108 is thermostatically controlled, so as to minimize temperature changes which would cause changes in the JFET bias current.

In an example embodiment, the input of amplifier package 8 is connected to receive signals from conductive element 5, the input of amplifier package 9 is connected to receive signals from conductive element 6, and the amplifier package is connected to receive signals from the conductive element 13A of vertical sensor assembly 13. The outputs of amplifier packages 8, 9, 20 and GPS antennas 511 and 512 and 513, are connected to the electronics package 90 by, in at least some example embodiments, thin shielded cables. The cables are thin, so as to reduce their capacitance with respect to the antenna elements and their effect on the electric field. The shields of these cables and the local commons or grounds of all the circuits in the sensor assembly 10 and sensor assembly 13 are electrically connected to conductive element 7, which is therefore the common element and the reference for all electrical field measurements. In some example embodiments, a differential amplifier circuit may be used in place of single input amplifier packages 8, 9—for example conductive elements 5 and 6 could be attached to the differential inputs of a single differential amplifier circuit with conductive element 7 being used as the common for the differential amplifier circuit.

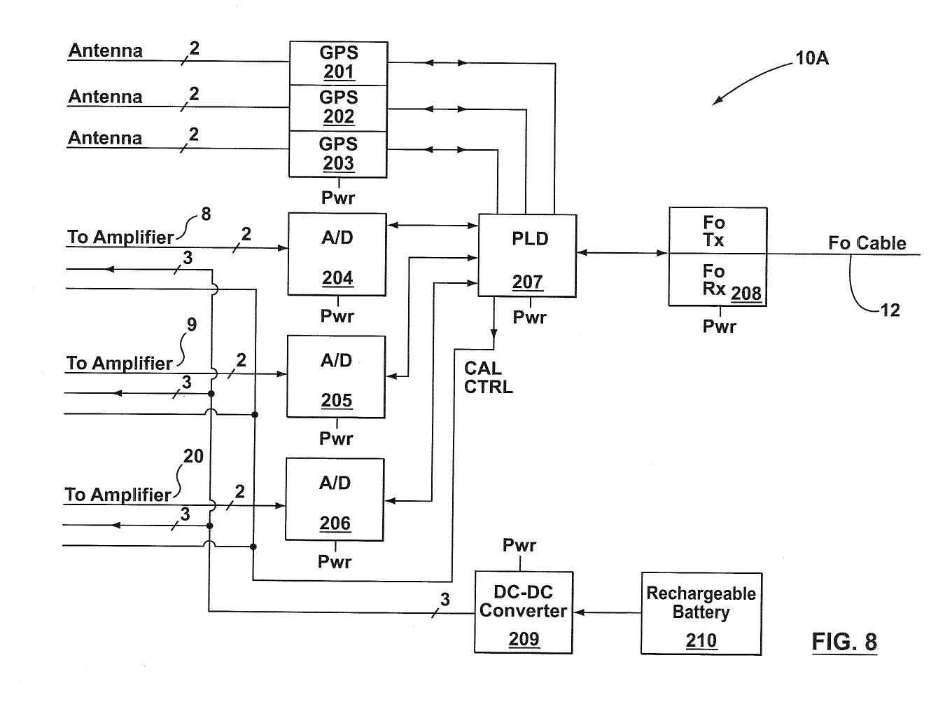

FIG. 8 is a block diagram of the electronics package 90. It includes a fiber optic transceiver 208 which allows timing signals and commands to be transmitted from a data collection computer 16 in the helicopter, and digital data to be transmitted to the data collection computer 16 in the helicopter via cable 12. The fiber optic transceiver 208 is interfaced to the other components of the electronics package 90 by a programmable logic device 207, which can be a FPGA (field programmable gate array) for example. Analog to digital converters 204, 205, 206 receive timing signals from the PLD 207, and transmit digitized versions of the output signal from the amplifier packages 8, 9, 20 to the PLD. In some example implementations, the analog to digital converters 204, 205, 206 operate at a sample rate of 1 kHz to 24 kHz which is sufficient to capture all the information in the input signals, to a bandwidth of at least 300 Hz up to as much as 10 kHz. The differential GPS receivers 201, 202, 203 are connected to the antennas 511, 512, 513 and send digital data to the PLD 207. The PLD optionally generates calibration signals to control the calibration generators 109 in the amplifier packages 8, 9, 20. The electronics may for example be powered by rechargeable battery 210 and DC-DC converter 209.

In an example embodiment, data collected by airborne data collection computer 16 and the data collected by the ground based data collection computer 19 is ultimately transferred over respective communication links 22, 23 (which may be wired or wireless links or may include physical transfer of a memory medium such as laser discs or flash memory cards) to a data processing computer 21 at which the electromagnetic field data obtained from airborne sensor assemblies 10, 13 and ground based magnetic field sensor assembly 17 and the GPS data from GPS antennas 511, 512, 513, and 18 is processed by the data processing computer 21 to determine the electrical resistivity structure of the earth. In some example embodiments, some or all of the functions performed by data processing computer 21 may be performed at one or both of the airborne or ground based data collection computers 16 and 19.

In operation, in some example implementations the airborne sensor systems 10 and 13 can be flown at a substantially constant speed in a series of parallel lines over a survey area to make a series of measurements of the low or audio frequency range (for example in the range of 10 Hz to 1000 Hz) electric field in three approximately orthogonal directions. Simultaneously, the stationary magnetic field sensor assembly 17 is located on the ground within or close to the survey region to also make a series of measurements of the low or audio frequency range (for example in the range of 10 Hz to 1000 Hz) horizontal magnetic field in two orthogonal directions. The stationary magnetic field sensor assembly 17 should, in at least some example uses, be placed a sufficient distance from any industrial electromagnetic field sources such as power lines so that natural audio-frequency magnetic fields dominate the signals received at the location of the stationary magnetic field sensor assembly 17. For example, in one application the distance of the stationary magnetic field sensor assembly 17 from a major power lines could be at least 3 km.

Thus, as a survey of a region is conducted, the airborne data collection computer 16 receives and stores a stream of digitized data that is representative of the naturally occurring audio frequency electric field vector E₍ₐᵢᵣ₎(t). Each of the airborne magnetic field measurements is stamped with a GPS location and time information received from the GPS antennas 511, 512, 513. At the same time, the ground based data collection computer 19 receives and stores a stream of digitized data that is representative of the naturally occurring audio frequency horizontal magnetic field vector H_{(ground)}(t) as measured by the ground based sensor coils 422. Each of the ground based magnetic field measurements is stamped at least with time information received from the GPS sensor 18, and in some embodiments also with location information. Thus, each of the airborne and stationary data collection computer systems 16, 19 respectively collect data records that each include two or three channels of data, each channel corresponding to the electric or magnetic field measurement taken by a respective one of the sensor coils or antenna electrode pairs.

At the signal processing computer 21, the data records from each of the airborne and stationary systems 16, 19 are merged in dependence on the GPS signal time data associated with each of the records to generate records that include three channels of digitized airborne electric field data, two channels of digitized ground magnetic field data, and four channels of GPS data from antennas 511, 512, 513, 18 with each record corresponding to measurements taken at substantially the same time at both the ground and airborne sensor systems.

The measurements from the airborne system are converted into an orthogonal frame of reference and into units of field strength (V/m). Specifically, the calibration signal strengths are processed to determine the response of the electronics to a unit voltage or charge. A theoretical calculation is performed, using the physical dimensions and relative positions of the conductive elements 5, 6, 7 of the sensor assembly 10 to determine the voltage or charge produced on each antenna element by an electric field of 1 V/m in each axial direction in an orthogonal frame of reference fixed relative to the airborne system 410. The theoretical calculation and the calibration results are combined to obtain a matrix of coefficients that relate the electric field vector to the digitized amplifier outputs. The inverse of this matrix is found by known techniques. The vector of measured outputs is multiplied by the inverse matrix to obtain the electric field vector in the airborne system frame of reference. This calculation is performed for every sample interval in the digitized electric field data.

In one example embodiment, the GPS data from antennas 511, 512, 513 is processed to yield the geographical position and altitude differences between the three sensors to a precision on the order of 0.1 m. These differences are used in data processing computer 21 to calculate the orientation of the electric field sensor assembly 10 (including the vertical field sensor 13) relative to geographic directions e.g. North-East-Down. This orientation information is used to calculate a matrix which transforms a vector expressed in the airborne system frame of reference, to a vector expressed in a geographic frame of reference. The electric field vectors calculated as in the previous paragraph are then multiplied by this matrix to transform them to a geographical frame of reference (North-East-Down). The calculation is repeated for every sample interval, obtaining a time series of electrical field components in the North, East and Down directions.

In some example embodiments, the vertical electric field sensor 13 is not present. In that case, the calculations described above are performed, using the approximation that the vertical component of the electric field is zero. In at least some implementations, this is a good approximation since the contribution of the vertical electric field sensor to the calculated horizontal components is in proportion to the tilt of the airborne sensor assembly 10, which can be kept small by appropriate flight procedures.

The orientation of the sensor coils 422 in the ground based assembly 420 are measured in geographical coordinates, e.g. by an operator using a magnetic compass with a correction for magnetic declination. The magnetic field components measured by magnetic field sensor assembly 17 are rotated into a North-East fame of reference using techniques similar to those described for the electric field sensors. Alternatively, the sensor coils 422 in magnetic field sensor assembly 17 are installed on the ground so that their axes bear North and East respectively, so that no rotation is needed.

In one example embodiment, frequency-domain processing is then performed on the data records either through applying narrow-band filters or applying Fast Fourier-transforms on multiple consecutive time blocks (by way of non limiting example, time blocks could each be 0.5-2 seconds long), or by use of known cascade decimation techniques (see e.g. Wight, D. E., F. X. Bostick, and H. W. Smith, Real time Fourier transformation of magnetotelluric data, report, Elecr. Geophs. Res. Lab., Uni. of Tex. at Austin, 1977) resulting in a time series of data that represents the electric and magnetic field in each of the axis directions at specific audio frequencies. This data includes a real and imaginary number representation of the electric field components for each of the North, East, and Down axis as measured in the air, and each of the North and East axis as measured on the ground. Certain frequencies can be filtered out—for example 60 Hz noise is removed in some embodiments.

In some example embodiments, the frequency domain processing is performed on the voltage or charge outputs of the airborne electric field sensors, and the magnetic field outputs of the ground sensors, and the subsequent calculations to convert to electric and magnetic field strength, and then to the geographical frame of reference, are performed on the frequency domain data. The various processing operations can be performed in a variety of ways and orders which are mathematically equivalent.

The result of the above calculation is a series of frequency domain electric and magnetic field measurements in a geographical frame of reference. Given the data derived as described in the previous paragraph, known techniques can be used to calculate the transfer functions between the horizontal magnetic field components at the ground station, and the horizontal electric field components form the airborne system. (Again see the Wight paper referenced.)

It is known that the theory of the magnetotelluric survey technique, confirmed by observations, shows that the electric component of the electromagnetic field is strongly affected by changes in the electrical conductivity structure of the earth below the point of observation, while the magnetic field is only weakly affected. Thus, the magnetic component at the location of the airborne sensor assembly 10 can be approximated by the magnetic component measured by magnetic field sensor assembly 17 at the fixed ground station. The transfer functions referred to in the previous paragraph can therefore be interpreted using known magnetotelluric theory to determine the electrical conductivity structure of the earth as a function of depth and to detect subsurface bodies and structures. (See for example (1) Vozoff, K., 1972, The magnetotelluric method in the exploration of sedimentary basins: Geophysics, 37,98-141. and (2) Anav, A., Cantarano, S., Cermli-Irelli, P., and Pallotino, G. V., 1976, A correlation method for measurement of variable magnetic fields: Inst. Elect. and Electron. Eng. Trans., Geosc. Elect., GE14, 106-1 14, which are hereby incorporated by reference).

Some sample implementations may include fewer sensors than described here. For example, the airborne sensor assembly 10 could measure only one horizontal electrical field component. The data can then be processed using known approximations to the techniques described above, for example those used in the interpretation of surveys known in the industry as “Scalar CSAMT” (Scalar Controlled Source Audio Magneto Telluric).

The interpretation described in the previous paragraphs allows the electrical resistivity of the earth, as a function of depth, to be determined even when there are no horizontal variations in the electrical resistivity. The data collection and processing techniques and methods described above in respect of airborne sensor assembly 10 can also be applied to airborne sensor assembly 500. In one non-limiting example implementation there is provided a geophysical survey system comprising: a first sensor system towed by an aircraft, having three sensors for measuring the electric component of low frequency (10 Hz-1,000 Hz) natural electromagnetic field in a survey area, the sensors each having a different relative orientation and measuring the electromagnetic field in a different relative direction; a second sensor system, located at a fixed position on the ground, having two sensors for measuring the magnetic component of the low frequency (10 Hz-1,000 Hz) natural electromagnetic field in or near the survey area, the sensors being oriented to sense the magnetic field in two perpendicular horizontal directions; and a processing system for calculating a set of first vector values over time in dependence on the electromagnetic field data measured through the first sensor system and calculating a set of second vector values over time in dependence on the electromagnetic field data measured through the second sensor system and comparing one or more characteristics of the first vector values and the second vector values to identify geophysical information about the survey area.

It will be appreciated by those skilled in the art that other variations of the embodiments described herein may also be practiced without departing from the scope of the invention. Other modifications are therefore possible.

What is claimed is:

1. A geophysical survey system comprising:
a first sensor system towed by an aircraft, having at least one airborne sensor for measuring electric components of a low frequency natural electromagnetic field in a survey area;
a second sensor system for positioning at a fixed position on the ground during a survey, having at least two ground based induction coil sensors for measuring magnetic components of a low frequency natural electromagnetic field in or near the survey area, the ground based sensors each being oriented to sense the magnetic components in different directions; and
a processing system for calculating a set of first vector values over time in dependence on the electric components measured through the first sensor system and calculating a set of second vector values over time in dependence on the magnetic components measured through the second sensor system and comparing one or more characteristics of the first vector values and the second vector values to identify geophysical information about the survey area.

2. The geophysical survey system of claim 1 wherein the first sensor system includes a continuous tubular support frame wherein two or more electrically conductive antenna elements are supported by the support frame in spaced apart but substantially constant positions relative to each other.

3. The geophysical survey system of claim 2 wherein the tubular support frame defines at least one continuous internal passage in which the antenna elements are located.

4. The geophysical survey system of claim 3 wherein the first sensor system includes a suspension rope system suspending the tubular support frame, and including a further antenna element supported on the suspension rope system for measuring a further electric component of the low frequency natural electromagnetic field, the antenna elements that are located in the support frame being supported in a substantially horizontal position by the support frame during flight.

5. The geophysical survey system of claim 3 wherein the antenna elements include tubular conductive sections that are part of an inner assembly located in the internal passage, the inner assembly including tubular non-conductive sections between each of the conductive sections.

6. The geophysical survey system of claim 2 wherein the antenna elements are elastically supported within tubular portions of the support frame.

7. The geophysical survey system of claim 6 wherein the antenna elements are each connected by elastomeric cord to an intermediate member which is in turn connected by elastomeric cord to the support frame.

8. The geophysical survey system of claim 1 wherein the first sensor system comprises at least three electrically conductive antenna elements in a non-colinear array, enabling the first sensor system to independently measure at least two electric components of the low frequency natural electromagnetic field oriented in different directions.

9. The geophysical survey system of claim 8 wherein the first sensor system includes multiple amplifier circuits for amplifying electric component signals received from the antenna elements, with one of the antenna elements being connected to all of the amplifier circuits as a common reference, while each of the other antenna elements is connected to an independent input of one of the amplifier circuits.

10. The geophysical survey system of claim 1 wherein the first sensor system includes one or more amplifier circuits for amplifying the measured electric components each of the amplifier circuits including at least one field effect transistor and a cooler for cooling the field effect transistor.

11. The geophysical survey system of claim 1 wherein the ground based induction coil sensors are oriented to sense the magnetic components in two different horizontal directions, and
the airborne sensors and ground based sensors measure electrical and magnetic components, respectively, occurring substantially within the 10 Hz to 1,000 Hz range.

12. A method of conducting a geophysical survey of a survey region, comprising:
measuring, using a towed airborne sensor system an electric component of a low frequency natural electromagnetic field in a survey area;
measuring, at a ground based sensor system during a survey, magnetic field components of the low frequency natural electromagnetic field in or near the survey area using at least two stationary induction coil sensors each being oriented to sense the magnetic field in different directions; and
calculating a set of first vector values over time in dependence on electromagnetic field data measured through the airborne sensor system and calculating a set of second vector values over time in dependence on electromagnetic field data measured through the ground based sensor system and comparing one or more characteristics of the first vector values and the second vector values to identify geophysical information about the survey area.

13. The method of claim 12 wherein the airborne sensor system comprises at least three electrically conductive antenna elements in a non-colinear array, and measuring an electronic component includes measuring at least two electric components of the low frequency natural electromagnetic field oriented in different directions.

14. An airborne sensor system for geophysical surveying, the airborne sensor system being towable by an aircraft and comprising:
a continuous tubular support frame defining at least one internal tubular passage; and
a plurality of conductive antenna elements supported at spaced apart locations within the internal tubular passage for measuring electric components of low frequency natural electromagnetic field in a survey area, the antenna elements each having a different relative orientation and measuring the electric components in at least two different relative directions.

15. The airborne sensor system of claim 14 wherein the antenna elements each include tubular conductive sections that are part of an internal assembly located in the internal tubular passage, the internal assembly including tubular non-conductive members separating the tubular conductive members.

16. The airborne sensor system of claim 15 wherein the internal assembly defines a tubular continuous inner passage in the form of a closed loop in which a multiple turn coil is installed as a means of sensing a magnetic field component of the natural magnetic field in addition to the electric field components sensed by the antenna elements.

17. The airborne sensor system of claim 14 wherein the support frame forms a tetrahedron or a loop that is circular or approximates a circle.

18. The airborne sensor system of claim 14 comprising a suspension rope system suspending the tubular support frame and including a further antenna element supported on the suspension rope system for measuring electric components of the electromagnetic field in a further direction.

19. The airborne sensor system claim 14 comprising a non-conductive tow rope and suspension rope system suspending the tubular support frame and a non-conductive communications link extending along the tow rope and suspension rope system for transmitting measured electric component data from the airborne sensor system to a data recording system on the aircraft.

20. The airborne sensor system of claim 14 wherein the antenna elements are elastically suspended by a two stage suspension system in which the antenna elements are each connected by elastomeric cord to an intermediate member which is in turn connected by elastomeric cord to the support frame.
